(19) United States
(12) Patent Application Publication
(10) Pub. No.: US 2023/0306527 A1
(43) Pub. Date: Sep. 28, 2023

(54) INFORMATION PROCESSING SYSTEM, TERMINAL DEVICE, INFORMATION PROCESSING DEVICE, AND INFORMATION PROCESSING METHOD

(71) Applicant: SEIKO EPSON CORPORATION, TOKYO (JP)

(72) Inventors: Yasuhiro FURUTA, Shimosuwa-machi (JP); Yasuhiro OSHIMA, MATSUMOTO-SHI (JP)

(21) Appl. No.: 18/191,002

(22) Filed: Mar. 28, 2023

(30) Foreign Application Priority Data
Mar. 28, 2022 (JP) 2022-051317

(51) Int. Cl. G06Q 40/12; G06F 3/12

(52) U.S. Cl. CPC G06Q 40/12; G06F 3/1203; G06F 3/1236; G06F 3/1267

(57) ABSTRACT

An information processing system includes a terminal device and an information processing device. The terminal device includes a print instructor that transmits a print instruction to print a print job, and an information transmitter that transmits predetermined information regarding the printing of the print job to the information processing device. The predetermined information includes expense-related information that is information regarding an expense for the printing of the print job, and connection-related information that is either one or both of information of a VPN connection and information of a login destination or is information based on at least one of the information of the VPN connection and the information of the login destination.

The present application is based on, and claims priority from JP Application Serial Number 2022-051317, filed Mar. 28, 2022, the disclosure of which is hereby incorporated by reference herein in its entirety.

### BACKGROUND

### 1. Technical Field

The present disclosure relates to an information processing system, a terminal device, an information processing device, and an information processing method.

### 2. Related Art

A user working from home may instruct a terminal device to print a document.

An expense management system described in JP-A-2014-49059 allows a user to enter, via a print setting screen, information indicating whether printing is performed for private purposes or for official purposes. In the expense management system, it is possible to distinguish payers that pay expenses for printing performed by the user working from home for private purposes and official purposes (see JP-A-2014-49059).

According to the technique described in JP-A-2014-49059, it is possible to classify expenses into an expense for printing for private purposes and an expense for printing for official purposes, but the accuracy of classifying the expenses may be degraded due to an incorrect entry or an intentional mistake because the user manually enters information indicating whether printing is performed for private purposes or official purposes.

### SUMMARY

To solve the problems described above, according to an aspect of the present disclosure, an information processing system includes a terminal device and an information processing device. The terminal device includes a print instructor that transmits a print instruction to print a print job, and an information transmitter that transmits predetermined information regarding the printing of the print job to the information processing device. The predetermined information includes expense-related information that is information regarding an expense for the printing of the print job, and connection-related information that is either one or both of information of a VPN connection and information of a login destination or is information based on at least one of the information of the VPN connection and the information of the login destination.

To solve the problems described above, according to another aspect of the present disclosure, a terminal device includes a print instructor that transmits a print instruction to print a print job, and an information transmitter that transmits predetermined information regarding the printing of the print job to an information processing device. The predetermined information includes expense-related information that is information regarding an expense for the printing of the print job, and connection-related information that is either one or both of information of a VPN connection and information of a login destination or is information based on at least one of the information of the VPN connection and the information of the login destination.

To solve the problems described above, according to still another aspect of the present disclosure, an information processing device includes a received information processor that processes predetermined information regarding printing of a print job received from a terminal device. The predetermined information includes expense-related information that is information regarding an expense for the printing of the print job, and connection-related information that is either one or both of information of a VPN connection and information of a login destination or is information based on at least one of the information of the VPN connection and the information of the login destination.

To solve the problems described above, according to still another aspect of the present disclosure, an information processing method includes causing a terminal device to transmit a print instruction to print a print job, and causing the terminal device to transmit predetermined information regarding the printing of the print job to an information processing device. The predetermined information includes expense-related information that is information regarding an expense for the printing of the print job, and connection-related information that is either one or both of information of a VPN connection and information of a login destination or is information based on at least one of the information of the VPN connection and the information of the login destination.

### BRIEF DESCRIPTION OF THE DRAWINGS

FIG. 1 is a diagram illustrating an example of the state of a first information processing system according to a first embodiment.

FIG. 2 is a diagram illustrating another example of the state of the first information processing system according to the first embodiment.

FIG. 3 is a diagram illustrating an example of a schematic configuration of a first terminal device according to the first embodiment.

FIG. 4 is a diagram illustrating an example of a schematic configuration of a first log server according to the first embodiment.

FIG. 5 is a diagram illustrating an example of a procedure for performing a process in the first information processing system according to the first embodiment.

FIG. 6 is a diagram illustrating another example of the procedure for performing the process in the first information processing system according to the first embodiment.

FIG. 7 is a diagram illustrating an example of the state of a second information processing system according to a second embodiment.

FIG. 8 is a diagram illustrating another example of the state of the second information processing system according to the second embodiment.

FIG. 9 is a diagram illustrating an example of a schematic configuration of a first print/log server according to the second embodiment.

FIG. 10 is a diagram illustrating an example of a procedure for performing a process in the second information processing system according to the second embodiment.

FIG. 11 is a diagram illustrating another example of the procedure for performing the process in the second information processing system according to the second embodiment.

FIG. 12 is a diagram illustrating an example of the state of a third information processing system according to a third embodiment.

FIG. 13 is a diagram illustrating another example of the state of the third information processing system according to the third embodiment.

FIG. 14 is a diagram illustrating an example of a schematic configuration of a second terminal device according to the third embodiment.

FIG. 15 is a diagram illustrating an example of a procedure for performing a process in the third information processing system according to the third embodiment.

FIG. 16 is a diagram illustrating another example of the procedure for performing the process in the third information processing system according to the third embodiment.

FIG. 17 is a diagram illustrating an example of the state of a fourth information processing system according to a fourth embodiment.

FIG. 18 is a diagram illustrating another example of the state of the fourth information processing system according to the fourth embodiment.

FIG. 19 is a diagram illustrating an example of a procedure for performing a process in the fourth information processing system according to the fourth embodiment.

FIG. 20 is a diagram illustrating another example of the procedure for performing the process in the fourth information processing system according to the fourth embodiment.

FIG. 21 is a diagram illustrating an example of a configuration of a first shared office according to a modification of the embodiments.

### DESCRIPTION OF EXEMPLARY EMBODIMENTS

Hereinafter, embodiments are described with reference to the drawings.

A first embodiment is described below.

In the present embodiment, a company is described as an example of an organization to which a user belongs. However, the organization to which the user belongs may be an organization other than a company in the present embodiment.

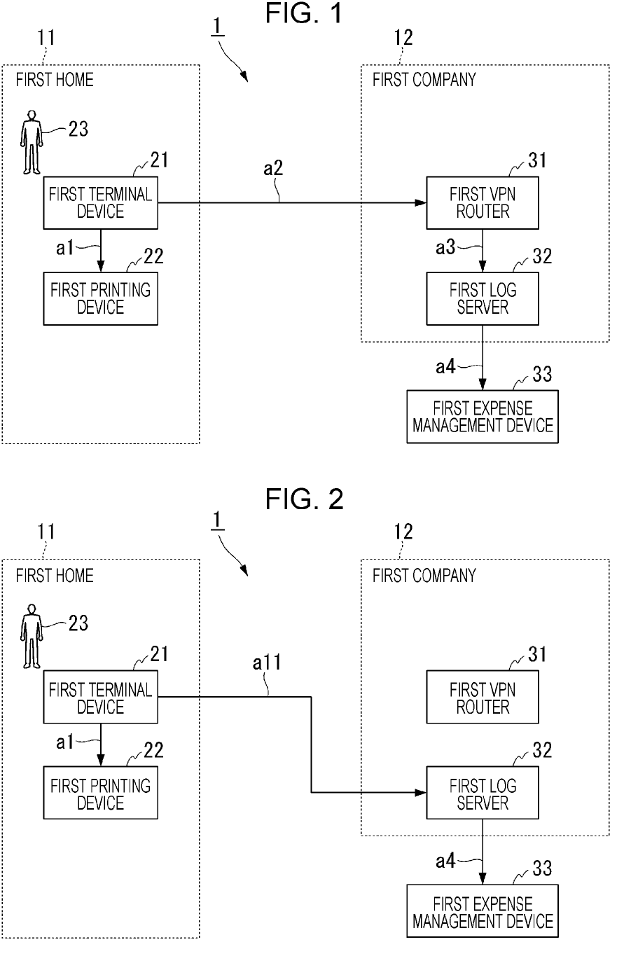

FIG. 1 is a diagram illustrating an example of the state of a first information processing system 1 according to the first embodiment.

FIG. 2 is a diagram illustrating another example of the state of the first information processing system 1 according to the first embodiment.

In the example illustrated in FIG. 1, a virtual private network (VPN) connection of a first terminal device 21 is established in the first information processing system 1. On the other hand, in the example illustrated in FIG. 2, the VPN connection of the first terminal device 21 is not established in the first information processing system 1.

The present embodiment indicates a first home 11 of a first user 23 and a first company 12 for which the first user 23 works as an example of locations.

FIGS. 1 and 2 illustrate the first user 23, the region of the first home 11, and the region of the first company 12.

The first information processing system 1 includes the first terminal device 21 of the first user 23, a first printing device 22 disposed at the first home 11, a first VPN router 31 disposed in the first company 12, a first log server 32 disposed in the first company 12, and a first expense management device 33 disposed at a location other than the first home 11 and the first company 12.

The first expense management device 33 may be disposed at any location. For example, the first expense management device 33 may be disposed as a cloud device. The first expense management device 33 may be disposed in the first company 12.

In the present embodiment, the first information processing system 1 includes the first expense management device 33. However, as another configuration example, the first information processing system 1 may not include the first expense management device 33.

In addition, in the present embodiment, the first log server 32 is disposed in the first company 12. However, as another configuration example, the first log server 32 may be disposed at any location. For example, the first log server 32 may be disposed as a cloud device.

In the present embodiment, the first user 23 uses the first terminal device 21 to work for the first company 12.

In the present embodiment, when the first user 23 works at a location other than the first company 12, the first user 23 connects the first terminal device 21 to the first VPN router 31 of the first company 12 via the VPN connection. On the other hand, when the first user 23 performs a private operation, the first user 23 does not connect the first terminal device 21 to the first VPN router 31 of the first company 12 via the VPN connection.

When the first user 23 connects the first terminal device 21 to the first VPN router 31 of the first company 12 via the VPN connection, the private operation may be prohibited.

In the present embodiment, the private operation means an operation other than an operation performed to work for the first company 12.

In the present embodiment, the first company 12 pays an expense required for printing performed to work for the first company 12, and does not pay an expense required for printing performed for the private operation.

The first information processing system 1 manages information regarding an expense to be paid by the first company 12.

In addition, the first information processing system 1 may manage information regarding an expense not to be paid by the first company 12.

In the present embodiment, non-private purposes are referred to as official purposes for convenience of explanation.

In a printing state illustrated in FIG. 1, the first user 23 and the first terminal device 21 are present at the first home 11.

In addition, the first user 23 connects the first terminal device 21 to the first VPN router 31 of the first company 12 via the VPN connection and works from home.

Furthermore, in the printing state illustrated in FIG. 1, the first user 23 operates the first terminal device 21 to cause the first printing device 22 present at the first home 11 to perform printing.

The first terminal device 21 is connected to the first printing device 22 by a first connection a1. The first connection a1 may be a connection using Universal Serial Bus (USB), for example.

The first terminal device 21 is connected to the first VPN router 31 by a second connection a2.

In the present embodiment, the first terminal device 21 directly transmits print data to the first printing device 22 to cause the first printing device 22 to perform printing.

This printing may be referred to as local printing, for example.

The first VPN router 31 is connected to the first log server 32 by a third connection a3. Therefore, the first terminal device 21 and the first log server 32 can communicate with each other.

The first log server 32 is connected to the first expense management device 33 by a fourth connection a4.

Each of the first connection a1, the second connection a2, the third connection a3, and the fourth connection a4 may be a wired connection or a wireless connection or may include a wired connection and a wireless connection.

A printing state illustrated in FIG. 2 is different from the printing state illustrated in FIG. 1 in that the first terminal device 21 is not connected to the first VPN router 31 via the VPN connection in the printing state illustrated in FIG. 2.

That is, the first user 23 uses the first terminal device 21 to perform a private operation.

In the printing state illustrated in FIG. 2, the first user 23 operates the first terminal device 21 to cause the first printing device 22 present at the first home 11 to perform printing.

The first terminal device 21 is connected to the first log server 32 by an eleventh connection a11.

The eleventh connection a11 may be a wired connection or a wireless connection or may include a wired connection and a wireless connection.

The first terminal device 21 may be a desktop computer, a laptop computer, a tablet computer, or the like, for example.

The first terminal device 21 may be owned by the first company 12 and lent to the first user 23 or may be owned by the first user 23, for example.

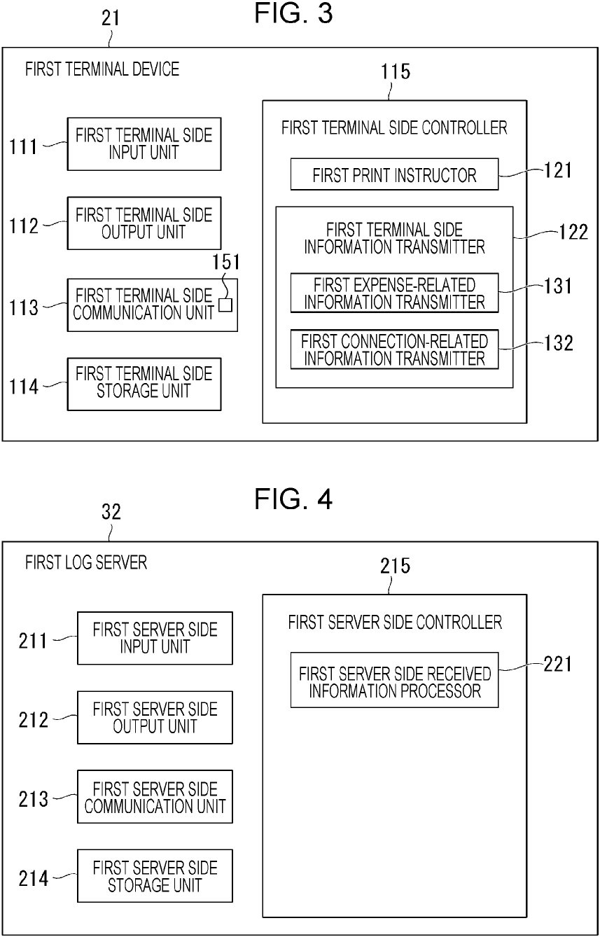

FIG. 3 is a diagram illustrating an example of a schematic configuration of the first terminal device 21 according to the first embodiment.

The first terminal device 21 includes a first terminal side input unit 111, a first terminal side output unit 112, a first terminal side communication unit 113, a first terminal side storage unit 114, and a first terminal side controller 115.

The first terminal side communication unit 113 includes a first terminal side VPN communication unit 151.

The first terminal side controller 115 includes a first print instructor 121 and a first terminal side information transmitter 122.

The first terminal side information transmitter 122 includes a first expense-related information transmitter 131 and a first connection-related information transmitter 132.

The first terminal side input unit 111 receives input from the outside.

The first terminal side input unit 111 includes an operation unit to be operated by the first user 23 and receives an instruction according to an operation performed on the operation unit, for example.

The first terminal side input unit 111 may receive information output from an external device, for example.

The first terminal side output unit 112 includes a display unit and outputs information to a screen of the display unit, for example.

The first terminal side output unit 112 includes an audio output unit and outputs audio information from the audio output unit, for example. The audio may be a voice, for example.

The first terminal side output unit 112 may output information to the external device, for example.

The operation unit and the display unit may be commonly constituted by a touch panel screen, for example.

The first terminal side communication unit 113 communicates with the external device. The first terminal side communication unit 113 is provided with a communication interface, for example.

The communication may be wired communication or wireless communication.

The communication may be communication using USB or communication using Wi-Fi, for example.

In the example illustrated in FIG. 3, the first terminal side communication unit 113 is provided as a functional unit different from the first terminal side input unit 111 and the first terminal side output unit 112. However, for example, a receiving function of the first terminal side communication unit 113 may be included in a function of the first terminal side input unit 111, and a transmitting function of the first terminal side communication unit 113 may be included in a function of the first terminal side output unit 112.

The first terminal side VPN communication unit 151 has a function of communicating with the first VPN router 31 of the first company 12 via the VPN connection.

The first terminal side communication unit 113 uses the first terminal side VPN communication unit 151 to communicate with the first VPN router 31 of the first company 12 via the VPN connection.

In the first terminal device 21, a dedicated connection source address may be used for the VPN connection, for example. As the dedicated connection source address, for example, an Internet Protocol (IP) address may be used.

The first terminal side storage unit 114 stores information.

The first terminal side storage unit 114 may store information of a history regarding printing, for example. The information of the history may be a history regarding official printing, a history regarding private printing, or a history regarding official printing and private printing, for example.

The first terminal side controller 115 performs various types of processing and various types of control.

The first terminal side controller 115 includes a processor such as a central processing unit (CPU) and causes the processor to execute a predetermined program so as to perform various types of processing and various types of control, for example.

The program may be stored in the first terminal side storage unit 114.

The first print instructor 121 transmits a print instruction to print a print job.

The first terminal side information transmitter 122 uses the first terminal side communication unit 113 to transmit log data including information regarding printing to the first log server 32.

In the present embodiment, the information regarding the printing includes information regarding an expense for the printing and information regarding a communication connection for the printing.

In the present embodiment, the information regarding the communication connection is information regarding whether or not the VPN connection is established.

The first expense-related information transmitter 131 causes expense-related information that is the information regarding the expense for the printing to be included in log data, and thus transmits the expense-related information to the first log server 32.

The first connection-related information transmitter 132 causes connection-related information that is the information regarding the communication connection to be included in log data, and thus transmits the connection-related information to the first log server 32.

Some or all of functions of the first print instructor 121 and the first terminal side information transmitter 122 may be configured as functions of a printer driver.

The first information processing system 1 is an example of an information processing system.

The first terminal device 21 is an example of a terminal device.

The first log server 32 is an example of an information processing device.

The first print instructor 121 is an example of a print instructor.

The first terminal side information transmitter 122 is an example of an information transmitter. The information transmitter transmits predetermined information regarding printing of a print job to the information processing device.

The predetermined information includes expense-related information that is information regarding an expense for the printing of the print job and connection-related information that is information of the VPN connection. The connection-related information may not be the information of the VPN connection and may be information based on the information of the VPN connection. The information based on the information of the VPN connection may be information obtained by processing the information of the VPN connection, for example.

The expense-related information may include information identifying whether the expense needs to be paid, for example.

As the information identifying whether the expense needs to be paid, any information may be used.

In a configuration in which expense-related information regarding an expense to be paid by the first company 12 is transmitted from the first log server 32 to the first terminal device 21 but expense-related information regarding other expenses is not transmitted from the first terminal device 21 to the first log server 32, the expense-related information may not include information identifying whether the expenses need to be paid.

The expense-related information may include information identifying a source that pays the expense.

As the information identifying the source that pays the expense, any information may be used. For example, as the information identifying the source that pays the expense, information of a VPN connection destination, information of a login destination, or the like may be used.

For example, a plurality of candidates for the source that pays the expense may be present.

In a configuration in which only one candidate for the source that pays the expense is present, the expense-related information may not include the information identifying the source that pays the expense.

In the present embodiment, a source that pays an expense for official printing is the company.

The expense-related information may include information identifying a destination to which the expense is paid.

As the information identifying the destination to which the expense is paid, any information may be used.

For example, a plurality of candidates for the destination to which the expense is paid may be present.

In a configuration in which only one candidate for the destination to which the expense is paid is present, the expense-related information may not include the information identifying the destination to which the expense is paid.

In the present embodiment, a destination to which an expense for official printing is paid is the user. In this case, as the information identifying the destination to which the expense is paid, for example, information identifying the user, information identifying a connection source address used by the user, information identifying a printing device used by the user, information identifying a location such as a home or a shared house to which the printing device belongs may be used.

A plurality of different printing devices may belong to a single location.

The expense-related information may include information specifying the amount of a resource used to print a print job.

The resource is arbitrary and may be a paper sheet, toner, ink, electric power, or the like, for example.

As the information specifying the amount of the resource, any information may be used. For example, as the information specifying the amount of the source, the number of paper sheets printed, the amount of toner or ink consumed, the amount of electric power consumed, or the like may be used.

As the expense, a fixed expense per number of paper sheets printed may be used.

The resource may be a resource consumed, for example.

When an expense required for printing is independent of the amount of a resource used to print a print job, the expense-related information may not include information specifying the amount of the resource used to print the print job. In such a case, for example, the expense required for the printing may be fixed regardless of the amount of the resource.

The connection-related information may include information identifying whether the printing of the print job is private printing or official printing.

In the present embodiment, when the printing of the print job is private printing, the first company 12 does not pay the expense, and when the printing of the print job is official printing, the first company 12 pays the expense.

The information identifying whether the printing of the print job is private printing or official printing may be common to other information, for example.

As the other information, for example, information identifying whether the VPN connection is established may be used. In the present embodiment, when the VPN connection is established, the other information indicates official printing, and when the VPN connection is not established, the other information indicates private printing.

For example, when an address of the connection source of the VPN connection is used, the address of the connection source may be used as the other information.

Information regarding the user may be included in either one or both of the expense-related information and the connection-related information.

The information regarding the user may include information of the name of the user or the like, for example.

FIG. 4 is a diagram illustrating an example of a schematic configuration of the first log server 32 according to the first embodiment.

The first log server 32 includes a first server side input unit 211, a first server side output unit 212, a first server side communication unit 213, a first server side storage unit 214, and a first server side controller 215.

The first server side controller 215 includes a first server side received information processor 221.

The first server side input unit 211 receives input from the outside.

The first server side input unit 211 includes an operation unit to be operated by an operator and receives an instruction corresponding to an operation performed on the operation unit, for example.

The first server side input unit 211 may receive information output from an external device, for example.

The first server side output unit 212 includes a display unit and outputs information to a screen of the display unit, for example.

The first server side output unit 212 may include an audio output unit and output audio information from the audio output unit, for example. The audio may be a voice, for example.

The first server side output unit 212 may output information to the external device, for example.

The operation unit and the display unit may be commonly constituted by a touch panel screen, for example.

The first server side communication unit 213 communicates with the external device. The first server side communication unit 213 may be provided with a communication interface, for example.

The communication may be wired communication or wireless communication.

The communication may be communication using USB or communication using Wi-Fi, for example.

In the example illustrated in FIG. 4, the first server side communication unit 213 is provided as a functional unit different from the first server side input unit 211 and the first server side output unit 212. However, for example, a receiving function of the first server side communication unit 213 may be included in a function of the first server side input unit 211, and a transmitting function of the first server side communication unit 213 may be included in a function of the first server side output unit 212.

The first server side storage unit 214 may store information.

The first server side controller 215 performs various types of processing and various types of control.

The first server side controller 215 includes a processor such as a CPU and causes the processor to execute a predetermined program so as to perform various types of processing and various types of control, for example.

The program may be stored in the first server side storage unit 214.

The first server side received information processor 221 causes a part or all of information included in log data received by the first log server 32 from the first terminal device 21 to be stored in the first server side storage unit 214.

The first server side received information processor 221 processes the information included in the log data received by the first log server 32 from the first terminal device 21.

In the present embodiment, the first server side received information processor 221 causes the first server side communication unit 213 to transmit, to the first expense management device 33, a part or all of the information included in the log data received from the first terminal device 21.

In this case, the first server side received information processor 221 may transmit a part or all of the information included in the log data received from the first terminal device 21 to the first expense management device 33 without changing the information or may process a part or all of the information included in the log data received from the first terminal device 21 and transmit the processed information to the first expense management device 33.

For example, the first server side received information processor 221 may extract information having a common attribute from information included in a plurality of pieces of log data received and transmit a set of the extracted information to the first expense management device 33.

As the common attribute, for example, one or more of information indicating whether an expense needs to be paid, a source that pays the expense, a destination to which the expense is paid, and the like may be used.

In addition, for example, when information specifying the amount of a resource used to print a print job is included in received log data, the first server side received information processor 221 may calculate an expense based on the amount of the resource and transmit information of the calculated expense to the first expense management device 33.

The first expense management device 33 is described below.

The first expense management device 33 receives information transmitted from the first log server 32 and manages the received information. The first expense management device 33 stores the received information or information obtained by processing the received information in a storage unit.

For example, the first expense management device 33 may extract information having a common attribute based on the information received from the first log server 32 and manage a set of the extracted information.

As the common attribute, for example, one or more of information indicating whether an expense needs to be paid, a source that pays the expense, a destination to which the expense is paid, and the like may be used.

When the extraction processing is performed by the first log server 32, the first expense management device 33 may not perform the extraction processing.

In addition, the first expense management device 33 may calculate an expense based on information specifying the amount of a resource used to print a print job and manage information of the calculated expense, for example.

When the calculation processing is performed by the first log server 32, the first expense management device 33 may not perform the calculation processing.

In the present embodiment, for example, the calculation of the expense may be performed by any one or more of the first terminal device 21, the first log server 32, and the first expense management device 33 or may be distributed to and performed by two or more of the first terminal device 21, the first log server 32, and the first expense management device 33.

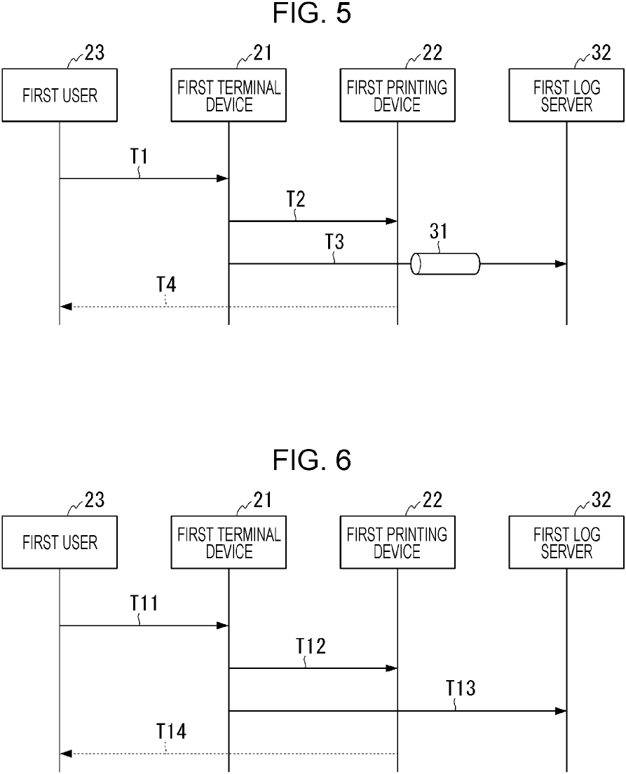

Examples of a procedure for performing a process in the first information processing system 1 are described with reference to FIGS. 5 and 6.

FIGS. 5 and 6 illustrates the first user 23, the first terminal device 21, the first printing device 22, and the first log server 32.

FIG. 5 is a diagram illustrating an example of the procedure for performing the process in the first information processing system 1 according to the first embodiment.

This example corresponds to the communication state illustrated in FIG. 1 and corresponds to a case where official printing is performed.

In a process T1, the first user 23 operates the operation unit of the first terminal device 21 to enter a print instruction into the first terminal device 21. As a result, the first terminal device 21 receives the print instruction.

In a process T2, the first terminal device 21 causes the first print instructor 121 to transmit, based on the received print instruction, print data indicating the print instruction to print a print job to the first printing device 22. As a result, the first printing device 22 receives the print data from the first terminal device 21 and prints the print job.

In a process T3, the first terminal device 21 causes the first terminal side information transmitter 122 to transmit log data including information regarding the printing of the print job to the first log server 32 via the first VPN router 31. As a result, the first log server 32 performs processing of storing the received log data, processing of transmitting information based on the log data to the first expense management device 33, and the like.

In a process T4, the first user 23 obtains printed matter generated by the first printing device 22.

The processing T4 is performed at any timing after the processing T2.

FIG. 6 is a diagram illustrating another example of the procedure for performing the process in the first information processing system 1 according to the first embodiment.

This example corresponds to the communication state illustrated in FIG. 2 and corresponds to a case where private printing is performed.

In a process T11, the first user 23 operates the operation unit of the first terminal device 21 to enter a print instruction into the first terminal device 21. As a result, the first terminal device 21 receives the print instruction.

In a process T12, the first terminal device 21 causes the first print instructor 121 to transmit, based on the received print instruction, print data indicating the print instruction to print a print job to the first printing device 22. As a result, the first printing device 22 receives the print data from the first terminal device 21 and prints the print job.

In a process T13, the first terminal device 21 causes the first terminal side information transmitter 122 to transmit log data including information regarding the printing of the print job to the first log server 32 without the VPN connection. As a result, the first log server 32 performs processing of storing the received log data, processing of transmitting information based on the log data to the first expense management device 33, and the like.

In a process T14, the first user 23 obtains printed matter generated by the first printing device 22.

The processing T14 is performed at any timing after the processing T12.

In the examples illustrated in FIGS. 5 and 6, every time the printing of a print job is performed, the first terminal device 21 transmits log data including information regarding the printing of the print job to the first log server 32.

As another configuration example, the first terminal device 21 may store information regarding printing performed on a print job in the first terminal side storage unit 114 and transmit log data including the information to the first log server 32 at a predetermined timing. The timing may be defined in advance or may be timings at fixed time intervals, for example.

In the first terminal device 21, the timing of performing printing and the timing of outputting log data including information regarding the printing may be the same or may be any other timings, for example. As a specific example, the timing of outputting the log data regarding the printing may be after the execution of the printing, during the execution of the printing, or before the execution of the printing.

The log data may be generated based on a history regarding the printing.

As described above, in the first information processing system 1 according to the present embodiment, it is possible to improve the accuracy of classifying expenses required for printing.

In the first information processing system 1 according to the present embodiment, for example, it is possible to identify official printing and private printing and appropriately classify expenses required for the printing. In the present embodiment, for example, it is possible to correctly calculate an expense for printing performed for official purposes when the user works from home.

In the first information processing system 1 according to the present embodiment, for example, an expense regarding official printing may be calculated and settled and an expense regarding private printing may not be calculated and settled.

In the first information processing system 1 according to the first embodiment, for example, the first expense management device 33 can automatically settle an expense.

In the present embodiment, as information regarding an expense, one or more of information indicating whether the expense needs to be paid, a source that pays the expense, a destination to which the expense is paid, the amount of a resource used, information indicating private printing or official printing, and the like can be used.

In the present embodiment, for example, the first terminal device 21 may cause the first terminal side information transmitter 122 to transmit only log data regarding official printing out of the log data regarding the official printing and log data regarding private printing to the first log server 32 or to transmit both of the log data regarding the official printing and the log data regarding the private printing to the first log server 32.

As another configuration example, a configuration in which the first terminal device 21 cannot be connected to the first log server 32 without the VPN connection of the first terminal device 21 to the first VPN router 31 may be used. In this configuration, for example, the first information processing system 1 does not go into the communication state illustrated in FIG. 2, and the first terminal device 21 does not notify the first log server 32 of log data regarding private printing.

In the present embodiment, it is possible to provide an information processing method of performing the information processing in the first information processing system 1.

A second embodiment is described below.

In the present embodiment, a company is described as an organization to which a user belongs. However, the organization to which the user belongs may be an organization other than a company in the present embodiment.

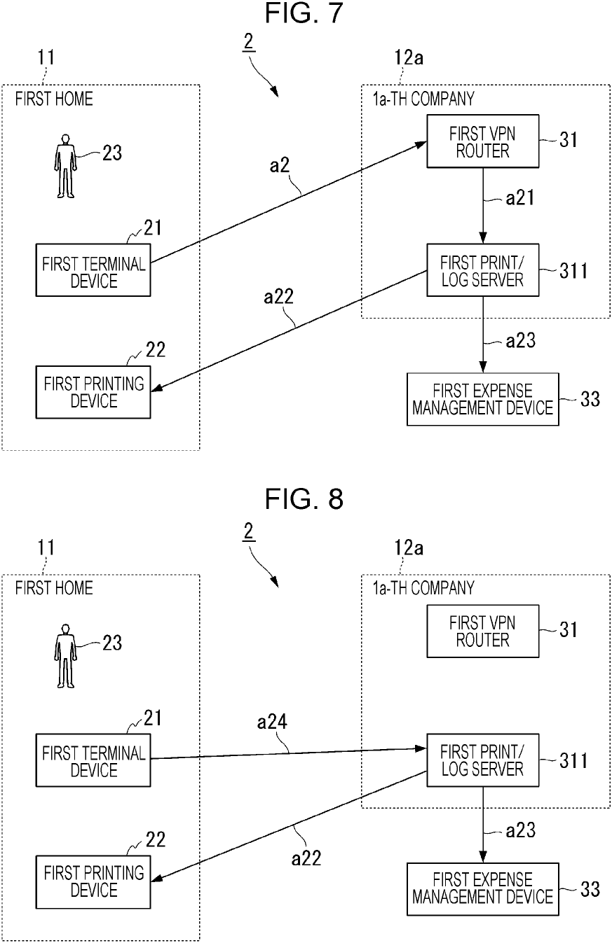

FIG. 7 is a diagram illustrating an example of the state of a second information processing system 2 according to the second embodiment.

FIG. 8 is a diagram illustrating another example of the state of the second information processing system 2 according to the second embodiment.

In the example illustrated in FIG. 7, a VPN connection of a first terminal device 21 is established in the second information processing system 2. On the other hand, in the example illustrated in FIG. 8, the VPN connection of the first terminal device 21 is not established in the second information processing system 2.

The second embodiment is different from the first embodiment in that a first print/log server 311 having a function of a print server and a function of a log server is used in the second embodiment.

In the present embodiment, the same constituent units as those in the examples illustrated in FIGS. 1 and 2 in the first embodiment are denoted by the same reference signs those in the examples illustrated in FIGS. 1 and 2 in the first embodiment and will not be described below in detail.

In the present embodiment, the first print/log server 311 having the function of the print server and the function of the log server is used. However, as another configuration example, a configuration in which the print server and the log server are provided as separate units may be used.

The present embodiment indicates a first home 11 of a first user 23 and a 1a-th company 12a for which the first user 23 works as an example of locations.

FIGS. 7 and 8 illustrate the first user 23, the region of the first home 11, and the region of the 1a-th company 12a.

The second information processing system 2 includes the first terminal device 21 of the first user 23, a first printing device 22 disposed at the first home 11, a first VPN router 31 disposed in the 1a-th company 12a, the first print/log server 311 disposed in the 1a-th company 12a, and a first expense management device 33 disposed at a location other than the first home 11 and the 1a-th company 12a.

In the present embodiment, the first print/log server 311 is disposed in the 1a-th company 12a. However, as another configuration example, the first print/log server 311 may be disposed at any location. For example, the first print/log server 311 may be disposed as a cloud device.

In the present embodiment, the first user 23 uses the first terminal device 21 to work for the 1a-th company 12a.

In the present embodiment, when the first user 23 works at a location other than the 1a-th company 12a, the first user 23 connects the first terminal device 21 to the first VPN router 31 of the 1a-th company 12a via the VPN connection. On the other hand, when the first user 23 performs a private operation, the first user 23 does not connect the first terminal device 21 to the first VPN router 31 of the 1a-th company 12a via the VPN connection.

When the first user 23 connects the first terminal device 21 to the first VPN router 31 of the 1a-th company 12a via the VPN connection, the private operation may be prohibited.

In a printing state illustrated in FIG. 7, the first user 23 and the first terminal device 21 are present at the first home 11.

In addition, the first user 23 connects the first terminal device 21 to the first VPN router 31 of the 1a-th company 12a via the VPN connection and works from home.

Furthermore, in the printing state illustrated in FIG. 7, the first user 23 operates the first terminal device 21 to cause the first printing device 22 present at the first home 11 to perform printing via the first print/log server 311.

The first VPN router 31 is connected to the first print/log server 311 by a 21st connection a21. Therefore, the first terminal device 21 and the first print/log server 311 can communicate with each other.

The first print/log server 311 is connected to the first printing device 22 by a 22nd connection a22.

The first print/log server 311 is connected to the first expense management device 33 by a 23rd connection a23.

Each of the 21st connection a21, the 22nd connection a22, and the 23rd connection a23 may be a wired connection or a wireless connection may include a wired connection and a wireless connection.

In the present embodiment, the first terminal device 21 transmits print data to the first printing device 22 via the first print/log server 311 disposed outside the first terminal device 21 so as to cause the first printing device 22 to perform printing.

This printing may be referred to as cloud printing, for example.

The printing state illustrated in FIG. 8 is different from the printing state illustrated in FIG. 7 in that the first terminal device 21 is not connected to the first VPN router 31 via the VPN connection in the printing state illustrated in FIG. 8.

That is, the first user 23 uses the first terminal device 21 to perform a private operation.

In the printing state illustrated in FIG. 8, the first user 23 operates the first terminal device 21 to causes the first printing device 22 present at the first home 11 to perform printing via the first print/log server 311.

The first terminal device 21 is connected to the first print/log server 311 by a 24th connection a24.

The 24th connection a24 may be a wired connection or a wireless connection or may include a wired connection and a wireless connection.

The configuration and operation of the first terminal device 21 in the second embodiment are different from those described in the first embodiment in that the first print instructor 121 transmits a print instruction to print a print job to the first print/log server 311 in the second embodiment. Other features in the second embodiment are the same as or similar to those in the first embodiment.

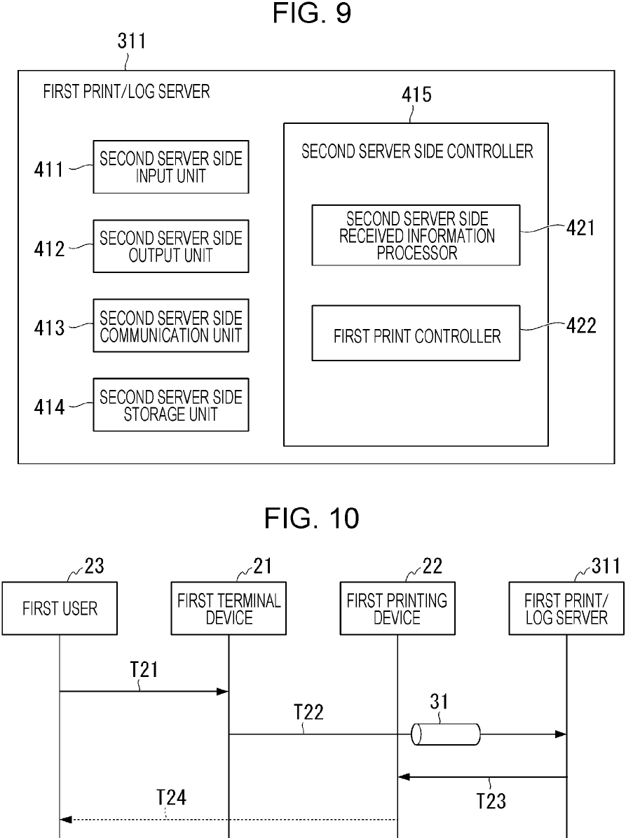

FIG. 9 is a diagram illustrating an example of a schematic configuration of the first print/log server 311 according to the second embodiment.

The first print/log server 311 includes a second server side input unit 411, a second server side output unit 412, a second server side communication unit 413, a second server side storage unit 414, and a second server side controller 415.

The second server side controller 415 includes a second server side received information processor 421 and a first print controller 422.

Functions of the second server side input unit 411, the second server side output unit 412, the second server side communication unit 413, and the second server side storage unit 414 are the same as or similar to the functions of the first server side input unit 211, the first server side output unit 212, the first server side communication unit 213, and the first server side storage unit 214 illustrated in FIG. 4.

In the present embodiment, the second server side communication unit 413 communicates with each of the first VPN router 31, the first printing device 22, and the first expense management device 33.

The second server side controller 415 performs various types of processing and various types of control.

The second server side controller 415 includes a processor such as a CPU and causes the processor to execute a predetermined program so as to perform various types of processing and various types of control, for example.

The program may be stored in the second server side storage unit 414.

A function of the second server side received information processor 421 is the same as or similar to the function of the first server side received information processor 221 illustrated in FIG. 4.

The second server side received information processor 421 causes a part or all of information included in log data received by the first print/log server 311 from the first terminal device 21 to be stored in the second server side storage unit 414.

The second server side received information processor 421 processes the information included in the log data received by the first print/log server 311 from the first terminal device 21.

In the present embodiment, the second server side received information processor 421 causes the second server side communication unit 413 to transmit a part or all of the information included in the log data received from the first terminal device 21 to the first expense management device 33. The first expense management device 33 receives the information transmitted from the first print/log server 311 and manages the received information.

In the present embodiment, for example, the calculation of an expense may be performed by one or more of the first terminal device 21, the first print/log server 311, and the first expense management device 33 or may be distributed to and performed by two or more of the first terminal device 21, the first print/log server 311, and the first expense management device 33.

The first print controller 422 performs control regarding printing.

For example, the first print controller 422 causes the second server side communication unit 413 to transmit, based on a print instruction to print a print job received from the first terminal device 21, the print instruction to print the print job to the first printing device 22.

In addition, for example, the first print controller 422 may have a function of causing the print job to be stored in the second server side storage unit 414 and causing the first printing device 22 to print the print job stored in the second server side storage unit 414.

The second server side storage unit 414 is an example of a storage unit.

Examples of a procedure for performing a process in the second information processing system 2 are described with reference to FIGS. 10 and 11.

FIGS. 10 and 11 illustrate the first user 23, the first terminal device 21, the first printing device 22, and the first print/log server 311.

FIG. 10 is a diagram illustrating an example of the procedure for performing the process in the second information processing system 2 according to the second embodiment.

This example corresponds to the communication state illustrated in FIG. 7 and corresponds to a case where official printing is performed.

In a process T21, the first user 23 operates the operation unit of the first terminal device 21 to enter a print instruction into the first terminal device 21. As a result, the first terminal device 21 receives the print instruction.

In a process T22, the first terminal device 21 causes the first print instructor 121 to transmit, based on the received print instruction, print data indicating the print instruction to print a print job to the first print/log server 311 via the first VPN router 31.

In addition, the first terminal device 21 causes the first terminal side information transmitter 122 to transmit log data including information regarding the printing of the print job to the first print/log server 311 via the first VPN router 31. As a result, the first print/log server 311 performs processing of storing the received log data, processing of transmitting information based on the log data to the first expense management device 33, and the like.

The print data and the log data may be integrated or separated, for example.

In a process T23, the first print/log server 311 causes the first print controller 422 to transmit, in accordance with the print instruction to print the print job received from the first terminal device 21, print data indicating the print instruction to print the print job to the first printing device 22. As a result, the first printing device 22 receives the print data from the first print/log server 311 and prints the print job.

In a process T24, the first user 23 obtains printed matter generated by the first printing device 22.

The processing T24 is performed at any timing after the processing T23.

FIG. 11 is a diagram illustrating another example of the procedure for performing the process in the second information processing system 2 according to the second embodiment.

This example corresponds to the communication state illustrated in FIG. 8 and corresponds to a case where private printing is performed.

In a process T31, the first user 23 operates the operation unit of the first terminal device 21 to enter a print instruction into the first terminal device 21. As a result, the first terminal device 21 receives the print instruction.

In a process T32, the first terminal device 21 causes the first print instructor 121 to transmit, based on the received print instruction, print data indicating the print instruction to print a print job to the first print/log server 311 without the VPN connection.

In addition, the first terminal device 21 causes the first terminal side information transmitter 122 to transmit log data including information regarding the printing of the print job to the first print/log server 311 without the VPN connection. As a result, the first print/log server 311 performs processing of storing the received log data, processing of transmitting information based on the log data to the first expense management device 33, and the like.

The print data and the log data may be integrated or separated, for example.

In a process T33, the first print/log server 311 causes the first print controller 422 to transmit, in accordance with the print instruction to print the print job received from the first terminal device 21, print data indicating the print instruction to print the print log to the first printing device 22. As a result, the first printing device 22 receives the print data from the first print/log server 311 and print the print job.

In a process T34, the first user 23 obtains printed matter generated by the first printing device 22.

The processing T34 is performed at any timing after the processing T33.

In the examples illustrated in FIGS. 10 and 11, every time the printing of a print job is performed, the first terminal device 21 transmits log data including information regarding the printing of the print job to the first print/log server 311.

As another configuration example, the first terminal device 21 may store information regarding printing performed on a print job in the first terminal side storage unit 114 and transmit log data including the information to the first print/log server 311 at a predetermined timing. The timing may be defined in advance or may be timings at fixed time intervals, for example.

In the first terminal device 21, the timing of performing printing and the timing of outputting log data including information regarding the printing may be the same or any other timings, for example. As a specific example, the timing of outputting the log data regarding the printing may be after the execution of the printing, during the execution of the printing, or before the execution of the printing.

The log data may be generated based on a history regarding the printing.

In the second information processing system 2 according to the present embodiment, it is possible to improve the accuracy of classifying expenses required for printing.

In the second information processing system 2 according to the present embodiment, for example, it is possible to identify official printing and private printing and appropriately classify expenses required for the printing. In the present embodiment, for example, it is possible to correctly calculate an expense for printing performed for official purposes when the user works from home.

In the second information processing system 2 according to the present embodiment, for example, an expense for official printing may be calculated and settled and an expense for private printing may not be calculated and settled.

In the second information processing system 2 according to the present embodiment, for example, the first expense management device 33 can automatically settle an expense.

In the present embodiment, as information regarding an expense, one or more of information indicating whether the expense needs to be paid, a source that pays the expense, a destination to which the expense is paid, the amount of a resource used, information indicating private printing or official printing, and the like can be used.

In the present embodiment, for example, the first terminal device 21 may cause the first terminal side information transmitter 122 to transmit only log data regarding official printing out of the log data regarding the official printing and log data regarding private printing to the first print/log server 311 or to transmit both of the log data regarding the official printing and the log data regarding the private printing to the first print/log server 311.

As another configuration example, a configuration in which the first terminal device 21 cannot be connected to the first print/log server 311 without the VPN connection of the first terminal device 21 to the first VPN router 31 may be used. In this configuration, for example, the second information processing system 2 does not goes into the communication state illustrated in FIG. 8, and the first terminal device 21 does not notify the first print/log server 311 of log data regarding private printing.

In the present embodiment, when log data and print data are transmitted from the first terminal device 21 to the first print/log server 311, the log data and the print data may not be clearly distinguished. In this case, various types of information may be distributed to the log data and the print data.

In the present embodiment, it is possible to provide an information processing method of performing the information processing in the second information processing system 2.

A third embodiment is described below.

In the present embodiment, a company is described as an example of an organization to which a user belongs. However, the organization to which the user belongs may be an organization other than a company in the present embodiment.

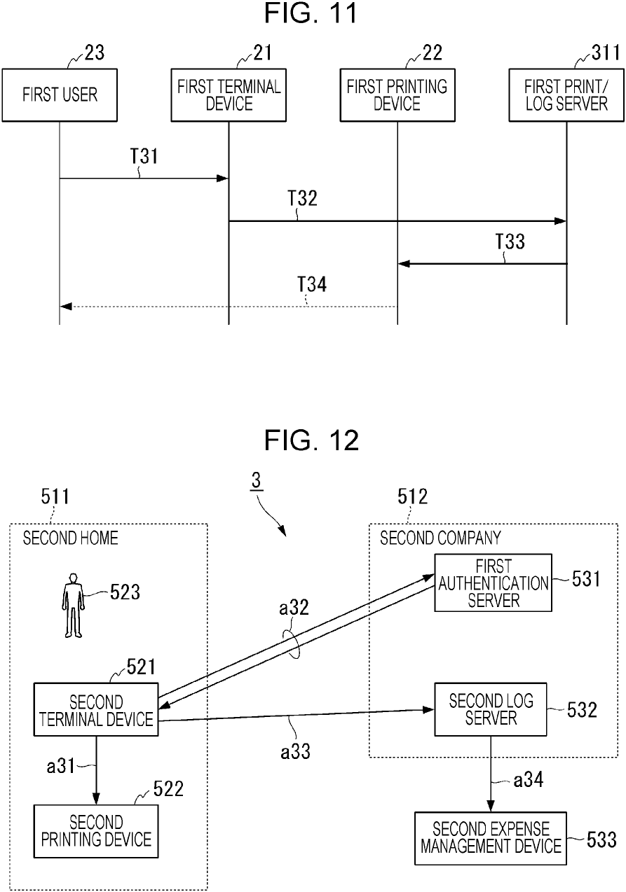

FIG. 12 is a diagram illustrating an example of the state of a third information processing system 3 according to the third embodiment.

FIG. 13 is a diagram illustrating another example of the state of the third information processing system 3 according to the third embodiment.

Information of a login destination of a second terminal device 521 in the third information processing system 3 in the example illustrated in FIG. 12 is different from information of a login destination of the second terminal device 521 in the third information processing system 3 in the example illustrated in FIG. 13.

In the present embodiment, a user account used by the user for work is different from a user account used by the same user for private purposes.

As the information of the login destination, various types of information may be used. For example, as information of a section to which the user belongs in the company or the like, domain information or information of an address of the connection source of a VPN connection may be used.

The information of the login destination may include information regarding the user during login to the second terminal device 521, for example.

Login information entered by the user in the terminal device may be a user name indicating the name of the user, a domain, and password information, for example. A part or all of these information items may be stored in the terminal device.

In addition, as the login information, information of a logon destination to be used by the user to log on to the terminal device may be used. When a plurality of logon destinations are present, for example, access rights may differ for each of the logon destinations.

The user name and the domain may be arranged in order of the user name, the at sign “@”, and the domain, for example.

The present embodiment indicates a second home 511 of a second user 523 and a second company 512 for which the second user 523 works as an example of locations.

FIGS. 12 and 13 illustrate the second user 523, the region of the second home 511, the region of the second company 512.

The third information processing system 3 includes the second terminal device 521 of the second user 523, a second printing device 522 disposed at the second home 511, a first authentication server 531 disposed in the second company 512, a second log server 532 disposed in the second company 512, a second expense management device 533 disposed at a location other than the second home 511 and the second company 512.

A function of the second printing device 522 is the same as or similar to the function of the first printing device 22 illustrated in FIGS. 1 and 2, for example.

In addition, a function of the second log server 532 is the same as or similar to the function of the first log server 32 illustrated in FIGS. 1 and 2, for example.

In addition, a function of the second expense management device 533 is the same as or similar to the function of the first expense management device 33 illustrated in FIGS. 1 and 2, for example.

The second expense management device 533 may be disposed at any location. For example, the second expense management device 533 may be disposed as a cloud device. The second expense management device 533 may be disposed in the second company 512.

In the present embodiment, the third information processing system 3 includes the second expense management device 533. However, as another configuration example, the third information processing system 3 may not include the second expense management device 533.

In addition, in the present embodiment, the first authentication server 531 is disposed in the second company 512. However, as another configuration example, the first authentication server 531 may be disposed at any location. For example, the first authentication server 531 may be disposed as a cloud device.

In addition, in the present embodiment, the second log server 532 is disposed in the second company 512. However, as another configuration example, the second log server 532 may be disposed at any location. For example, the second log server 532 may be disposed as a cloud device.

In the present embodiment, the second user 523 uses the second terminal device 521 to work for the second company 512.

In the present embodiment, when the second user 523 works at a location other than the second company 512, the second user 523 uses the second terminal device 521 to use a domain of the second company 512 as a login destination and is authenticated by the first authentication server 531.

On the other hand, when the second user 523 performs a private operation, the second user 523 does not user the domain of the second company 512 as a login destination.

In the present embodiment, the private operation means an operation other than an operation performed to work for the second company 512.

In the present embodiment, an expense required for printing performed to work for the second company 512 is paid by the second company 512, and an expense required for printing performed for the private operation is not paid by the second company 512.

The third information processing system 3 manages information regarding an expense to be paid by the second company 512.

In addition, the third information processing system 3 may manage information regarding an expense not to be paid by the second company 512.

In the present embodiment, non-private purposes are referred to as official purposes for convenience of explanation.

In the printing state illustrated in FIG. 12, the second user 523 and the second terminal device 521 are present at the second home 511.

In addition, in the printing state illustrated in FIG. 12, the second user 523 uses the second terminal device 521 to use the domain of the second company 512 as the login destination and is authenticated by the first authentication server 531.

Furthermore, in the printing state illustrated in FIG. 12, the second user 523 operates the second terminal device 521 to cause the second printing device 522 present at the second home 511 to perform printing.

The second terminal device 521 is connected to the second printing device 522 by a 31st connection a31. The 31st connection a31 may be a connection using USB, for example.

The second terminal device 521 is connected to the first authentication server 531 by a 32nd connection a32.

In the present embodiment, the second terminal device 521 directly transmits print data to the second printing device 522 to cause the second printing device 522 to perform printing.

This printing may be referred to as local printing, for example.

The second terminal device 521 is connected to the second log server 532 by a 33rd connection a33. Therefore, the second terminal device 521 and the second log server 532 can communicate with each other.

The second log server 532 is connected to the second expense management device 533 by a 34th connection a34.

Each of the 31st connection a31, the 32nd connection a32, the 33rd connection a33, and the 34th connection a34 may be a wired connection or a wireless connection or may include a wired connection and a wireless connection.

A printing state illustrated in FIG. 13 is different from the printing state illustrated in FIG. 12 in that the second terminal device 521 does not use the domain of the second company 512 as the login destination in the printing state illustrated in FIG. 13. In this case, the second terminal device 521 does not need to be authenticated by the first authentication server 531.

That is, the second user 523 uses the second terminal device 521 to perform a private operation.

In the printing state illustrated in FIG. 13, the second user 523 operates the second terminal device 521 to cause the second printing device 522 present at the second home 511 to perform printing.

The second terminal device 521 may be a desktop computer, a laptop computer, or the like, for example.

The second terminal device 521 may be owned by the second company 512 and lent to the second user 523 or may be owned by the second user 523, for example.

The first authentication server 531 is described below.

The first authentication server 531 receives an authentication request from the second terminal device 521. When the first authentication server 531 performs authentication processing based on the received authentication request so as to determine that the authentication request is valid, the first authentication server 531 gives, to the second terminal device 521, a communication right to use the domain of the second company 512 as a login destination.

On the other hand, when the first authentication server 531 determines that the authentication request is invalid, the first authentication server 531 does not give the communication right to the second terminal device 521.

As information of the authentication request, any information may be used. For example, as the information of the authentication request, information such as the user name of the second user 523 and a password may be used.

In addition, for example, in a configuration in which the second user 523 can select a plurality of access rights using the second terminal device 521, information of a selected access right may be used as the information of the authentication request.

The function of the first authentication server 531 may be included in the second log server 532, for example.

Functions of authentication servers may be provided for each of organizations such as companies, for example. In this case, an authentication server used may identify an organization corresponding to the authentication server used.

As another configuration example, when information such as login names or domains differs for each organization, an organization can be identified based on the information without using an authentication server.

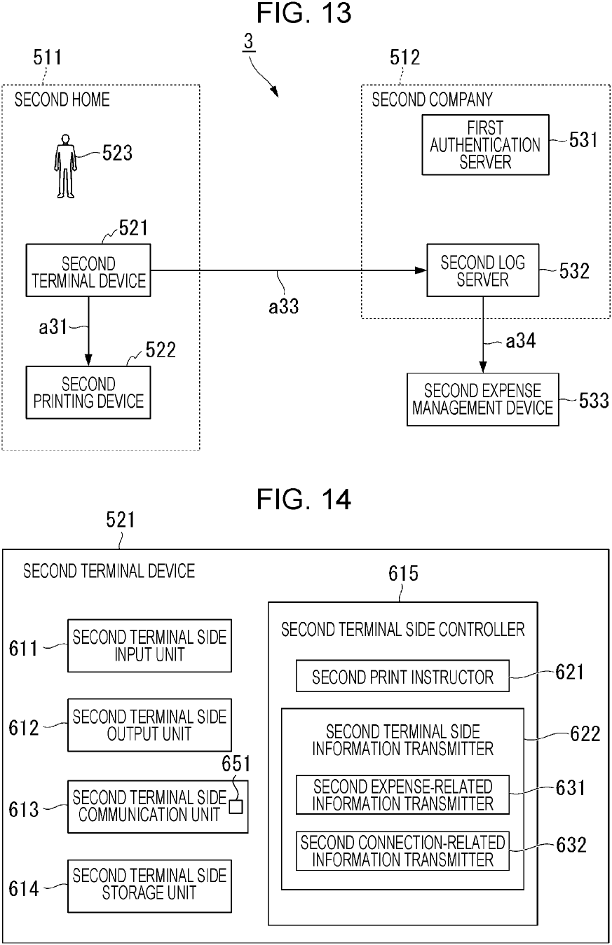

FIG. 14 is a diagram illustrating an example of a schematic configuration of the second terminal device 521 according to the third embodiment.

The second terminal device 521 includes a second terminal side input unit 611, a second terminal side output unit 612, a second terminal side communication unit 613, a second terminal side storage unit 614, and a second terminal side controller 615.

The second terminal side communication unit 613 includes a second terminal side authentication communication unit 651.

The second terminal side controller 615 includes a second print instructor 621 and a second terminal side information transmitter 622.

The second terminal side information transmitter 622 includes a second expense-related information transmitter 631, and a second connection-related information transmitter 632.

Functions of the second terminal side input unit 611, the second terminal side output unit 612, and the second terminal side storage unit 614 are the same as or similar to the functions of the first terminal side input unit 111, the first terminal side output unit 112, and the first terminal side storage unit 114 illustrated in FIG. 3.

The second terminal side communication unit 613 communicates with an external device. The second terminal side communication unit 613 is provided with a communication interface, for example.

The communication may be wired communication or wireless communication.

The communication may be communication using USB or communication using Wi-Fi, for example.

In the example illustrated in FIG. 14, the second terminal side communication unit 613 is provided as a functional unit different from the second terminal side input unit 611 and the second terminal side output unit 612. However, for example, a receiving function of the second terminal side communication unit 613 may be included in a function of the second terminal side input unit 611, and a transmitting function of the second terminal side communication unit 613 may be included in a function of the second terminal side output unit 612.

The second terminal side authentication communication unit 651 has a function of communicating with the first authentication server 531 of the second company 512.

The second terminal side authentication communication unit 651 transmits, to the first authentication server 531 of the second company 512, an authentication request to request a communication right to use the domain of the second company 512 as a login destination. When the authentication request is authenticated as a valid request by the first authentication server 531, the second terminal side authentication communication unit 651 uses the domain of the second company 512 as the login destination to connect to and communicate with the second log server 532.

The second terminal side communication unit 613 uses the second terminal side authentication communication unit 651 to connect to and communicate with the first authentication server 531 of the second company 512.

The second terminal side controller 615 performs various types of processing and various types of control.

The second terminal side controller 615 includes a processor such as a CPU and causes the processor to execute a predetermined program so as to perform various types of processing and various types of control, for example.

The program may be stored in the second terminal side storage unit 614.

The second print instructor 621 transmits a print instruction to print a print job.

The second terminal side information transmitter 622 uses the second terminal side communication unit 613 to transmit log data including information regarding printing to the second log server 532.

In the present embodiment, the information regarding the printing includes information regarding an expense for the printing and information regarding a communication connection for the printing.

In the present embodiment, the information regarding the communication connection is information regarding the login destination. The information regarding the login destination includes information indicating whether the domain of the second company 512 is used as the login destination.

A function of the second expense-related information transmitter 631 is the same as or similar to the function of the first expense-related information transmitter 131 illustrated in FIG. 3, for example.

The second connection-related information transmitter 632 causes connection-related information regarding the communication connection to be included in log data and thus transmits the connection-related information to the second log server 532.

Some or all of the functions of the second print instructor 621 and the second terminal side information transmitter 622 may be configured as functions of a printer driver.

The third information processing system 3 is an example of the information processing system.

The second terminal device 521 is an example of the terminal device.

The second log server 532 is an example of the information processing device.

The second print instructor 621 is an example of the print instructor.

The second terminal side information transmitter 622 is an example of the information transmitter. The information transmitter transmits predetermined information regarding printing of a print job to the information processing device.

The predetermined information includes expense-related information regarding an expense for the printing of the print job and connection-related information regarding a domain of a login destination. The connection-related information may not be information of the domain and may be information based on the information of the domain. The information based on the information of the domain may be information obtained by processing the information of the domain, for example.

The expense-related information may be the same as or similar to the expense-related information described in the first embodiment, for example.

The connection-related information may include information identifying whether the printing of the print job is private printing or official printing.

In the present embodiment, when printing of a print job is private printing, the second company 512 does not pay an expense for the printing, and when printing of a print job is official printing, the second company 512 pays an expense for the printing.

The information identifying whether the printing is private printing or official printing may be common to other information, for example.

As the other information, for example, information identifying whether the domain of the second company 512 is used as the login destination may be used. In the present embodiment, when the domain of the second company 512 is used as the login destination, the information indicates official printing. When the domain of the second company 512 is not used as the login destination, the information indicates private printing.

In the present embodiment, for example, the calculation of an expense may be performed by any one or more of the second terminal device 521, the second log server 532, and the second expense management device 533 or may be distributed to and performed by two or more of the second terminal device 521, the second log server 532, and the second expense management device 533.

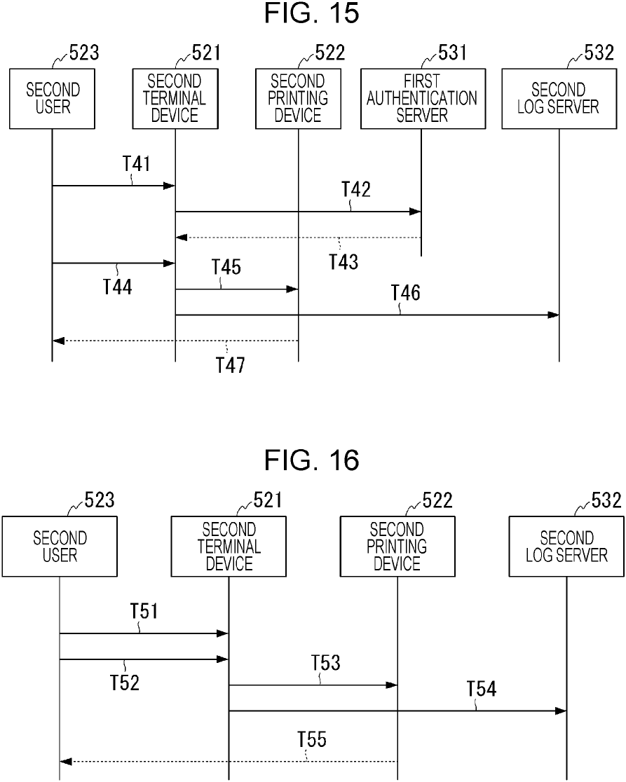

Examples of a procedure for performing a process in the third information processing system 3 are described with reference to FIGS. 15 and 16.

FIGS. 15 and 16 illustrate the second user 523, the second terminal device 521, the second printing device 522, the first authentication server 531, and the second log server 532.

FIG. 15 is a diagram illustrating an example of the procedure for performing the process in the third information processing system 3 according to the third embodiment.

This example corresponds to the communication state illustrated in FIG. 12 and corresponds to a case where official printing is performed.

In a process T41, the second user 523 operates the operation unit of the second terminal device 521 to perform login.

This example indicates a case where the domain of the second company 512 is used as a login destination.

In a process T42, the second terminal device 521 causes the second terminal side authentication communication unit 651 to transmit, to the first authentication server 531, an authentication request regarding the use of the domain of the second company 512 as the login destination.

In a process T43, when the first authentication server 531 authenticates the authentication request as a valid request, the first authentication server 531 transmits, to the second terminal device 521, information indicating that the authentication request is valid. As a result, the second terminal device 521 receives the information indicating that the authentication request is valid.

In a process T44, the second user 523 operates the operation unit of the second terminal device 521 to enter a print instruction into the second terminal device 521. As a result, the second terminal device 521 receives the print instruction.

In a process T45, the second terminal device 521 causes the second print instructor 621 to transmit, based on the received print instruction, print data indicating the print instruction to print a print job to the second printing device 522. As a result, the second printing device 522 receives the print data from the second terminal device 521 and print the print job.

In a process T46, the second terminal device 521 causes the second terminal side information transmitter 622 to transmit log data including information regarding the printing of the print job to the second log server 532 using authentication information. As a result, the second log server 532 performs processing of storing the received log data, processing of transmitting information based on the log data to the second expense management device 533, and the like.

In a process T47, the second user 523 obtains printed matter generated by the second printing device 522.

The processing T47 is performed at any timing after the processing T45.

FIG. 16 is a diagram illustrating another example of the procedure for performing the process in the third information processing system 3 according to the third embodiment.

This example corresponds to the communication state illustrated in FIG. 13 and corresponds to a case where private printing is performed.

In a process T51, the second user 523 operates the operation unit of the second terminal device 521 to perform login.

In this example, the domain of the second company 512 is not used as a login destination.

In this example, a private domain destination is used as a login destination.

In a process T52, the second user 523 operates the operation unit of the second terminal device 521 to enter a print instruction into the second terminal device 521. As a result, the second terminal device 521 receives the print instruction.

In a process T53, the second terminal device 521 causes the second print instructor 621 to transmit, based on the received print instruction, print data indicating the print instruction to print a print job to the second printing device 522. As a result, the second printing device 522 receives the print data from the second terminal device 521 and print the print job.

In a process T54, the second terminal device 521 causes the second terminal side information transmitter 622 to transmit log data including information regarding the printing of the print job to the second log server 532. As a result, the second log server 532 performs processing of storing the received log data, processing of transmitting information based on the log data to the second expense management device 533, and the like.

In a process T55, the second user 523 obtains printed matter generated by the second printing device 522.

The processing T55 is performed at any timing after the processing T53.

In the examples illustrated in FIGS. 15 and 16, every time the printing of a print job is performed, the second terminal device 521 transmits log data including information regarding the printing of the print job to the second log server 532.

As another configuration example, the second terminal device 521 may store information regarding printing performed on a print job in the second terminal side storage unit 614 and transmit log data including the information to the second log server 532 at a predetermined timing. The timing may be defined in advance or may be timings at fixed time intervals, for example.

In the second terminal device 521, the timing of performing printing and the timing of outputting log data including regarding the printing may be the same or may be any other timings, for example. As a specific example, the timing of outputting the log data regarding the printing may be after the execution of the printing, during the execution of the printing, or before the execution of the printing.

The log data may be generated based on a history regarding the printing.

In the third information processing system 3 according to the third embodiment, it is possible to improve the accuracy of classifying expenses required for printing.

In the third information processing system 3 according to the present embodiment, for example, it is possible to identify official printing and private printing and appropriately classify expenses required for the printing. In the present embodiment, for example, it is possible to correctly calculate an expense for printing performed for official purposes when the user works from home.

In the third information processing system 3 according to the present embodiment, for example, an expense regarding official printing may be calculated and settled and an expense regarding private printing may not be calculated and settled.

In the third information processing system 3 according to the present embodiment, for example, the second expense management device 533 can automatically settle an expense.

In the present embodiment, as information regarding an expense, one or more of information indicating whether the expense needs to be paid, a source that pays the expense, a destination to which the expense is paid, the amount of a resource used, and information indicating private printing or official printing can be used.

In the present embodiment, for example, the second terminal device 521 may cause the second terminal side information transmitter 622 to transmit only log data regarding official printing out of the log data regarding the official printing and log data regarding private printing to the second log server 532 or to transmit both of the log data regarding the official printing and the log data regarding the private printing to the second log server 532.

In the present embodiment, it is possible to provide an information processing method of performing the information processing in the third information processing system 3.

A fourth embodiment is described below.

In the present embodiment, a company is described as an example of an organization to which a user belongs. However, the organization to which the user belongs may be an organization other than a company in the present embodiment.

FIG. 17 is a diagram illustrating an example of the state of a fourth information processing system 4 according to the fourth embodiment.

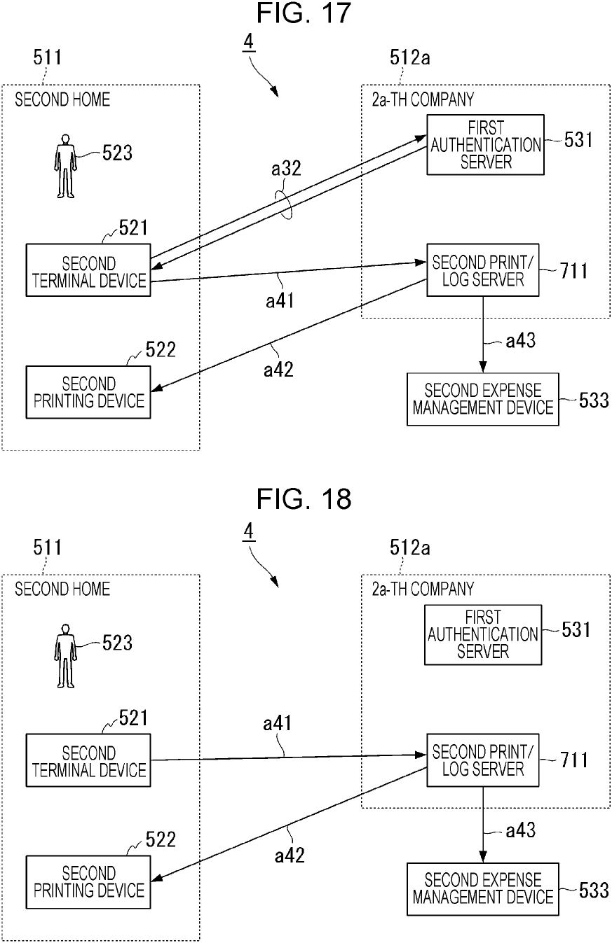

FIG. 18 is a diagram illustrating another example of the state of the fourth information processing system 4 according to the fourth embodiment.

Information of a login destination of a second terminal device 521 in the fourth information processing system 4 in the example illustrated in FIG. 17 is different from information of a login destination of the second terminal device 521 in the fourth information processing system 4 in the example illustrated in FIG. 18.

The fourth embodiment is different from the third embodiment in that a second print/log server 711 having a function of a print server and a function of a log server is used in the fourth embodiment.

In the present embodiment, the same constituent units as those in the examples illustrated in FIGS. 12 and 13 in the third embodiment are denoted by the same reference signs as those in the examples illustrated in FIGS. 12 and 13 in the third embodiment and will not be described below in detail.

In the present embodiment, the second print/log server 711 having the function of the print server and the function of the log server is used. However, as another configuration example, a configuration in which the print server and the log server are provided as separate units may be used.

In addition, the second print/log server 711 may include a function of a first authentication server 531, for example.

The present embodiment indicates a second home 511 of a second user 523 and a 2a-th company 512a for which the second user 523 works as an example of locations.

FIGS. 17 and 18 illustrate the second user 523, the region of the second home 511, and the 2a-th company 512a.

The fourth information processing system 4 includes the second terminal device 521 of the second user 523, a second printing device 522 disposed at the second home 511, the first authentication server 531 disposed in the 2a-th company 512a, the second print/log server 711 disposed in the 2a-th company 512a, and a second expense management device 533 disposed at a location other than the second home 511 and the 2a-th company 512a.

A function of the second print/log server 711 is the same as or similar to the function of the first print/log server 311 illustrated in FIGS. 7 and 8, for example.

In the present embodiment, the second print/log server 711 is disposed in the 2a-th company 512a. However, as another configuration example, the second print/log server 711 may be disposed at any location. For example, the second print/log server 711 may be disposed as a cloud device.

In the present embodiment, the second user 523 uses the second terminal device 521 to work for the 2a-th company 512a.

In the present embodiment, when the second user 523 works at a location other than the 2a-th company 512a, the second user 523 uses the second terminal device 521 to use the domain of the 2a-th company 512a as a login destination and is authenticated by the first authentication server 531.

On the other hand, when the second user 523 performs a private operation, the second user 523 does not use the domain of the 2a-th company 512a as the login destination.

In the present embodiment, the private operation means an operation other than an operation performed to work for the 2a-th company 512a.

In the present embodiment, an expense required for printing performed to work for the 2a-th company 512a is paid by the 2a-th company 512a, and an expense required for printing performed for the private operation is not paid by the 2a-th company 512a.

The fourth information processing system 4 manages information regarding an expense to be paid by the 2a-th company 512a.

In addition, the fourth information processing system 4 may manage information regarding an expense not to be paid by the 2a-th company 512.

In the present embodiment, non-private purposes are referred to as official purposes for convenience of explanation.

In a printing state illustrated in FIG. 17, the second user 523 and the second terminal device 521 are present at the second home 511.

In addition, in the printing state illustrated in FIG. 17, the second user 523 uses the second terminal device 521 to use the domain of the 2a-th company 512a as the login destination and is authenticated by the first authentication server 531.

Furthermore, in the printing state illustrated in FIG. 17, the second user 523 operates the second terminal device 521 to cause the second printing device 522 present at the second home 511 to perform printing via the second print/log server 711.

The second terminal device 521 is connected to the second print/log server 711 by a 41st connection a41.

The second print/log server 711 is connected to the second printing device 522 by a 42nd connection a42.

the second print/log server 711 is connected to the second expense management device 533 by a 43rd connection a43.

Each of the 41st connection a41, the 42nd connection a42, and the 43rd connection a43 may be a wired connection or a wireless connection or may include a wired connection and a wireless connection.

In the present embodiment, the second terminal device 521 transmits print data to the second printing device 522 via the second print/log server 711 disposed outside the second terminal device 521 so as to cause the second printing device 522 to perform printing.

This printing may be referred to as cloud printing, for example.

In a printing state illustrated in FIG. 18, the second terminal device 521 does not use the domain of the 2a-th company 512a as the login destination. This state is different from the printing state illustrated in FIG. 17. In this case, the second terminal device 521 does not need to be authenticated by the first authentication server 531.

That is, the second user 523 uses the second terminal device 521 to perform a private operation.

In the printing state illustrated in FIG. 18, the second user 523 operates the second terminal device 521 to cause the second printing device 522 present at the second home 511 to perform printing via the second print/log server 711.

The configuration and operation of the second terminal device 521 in the fourth embodiment are different from those described in the third embodiment in that the second print instructor 621 transmits a print instruction to print a print job to the second print/log server 711 in the fourth embodiment. Other features in the fourth embodiment are the same as or similar to those in the third embodiment.

In the present embodiment, for example, the calculation of an expense may be performed by one or more of the second terminal device 521, the second print/log server 711, and the second expense management device 533 or may be distributed to and performed by two or more of the second terminal device 521, the second print/log server 711, and the second expense management device 533.

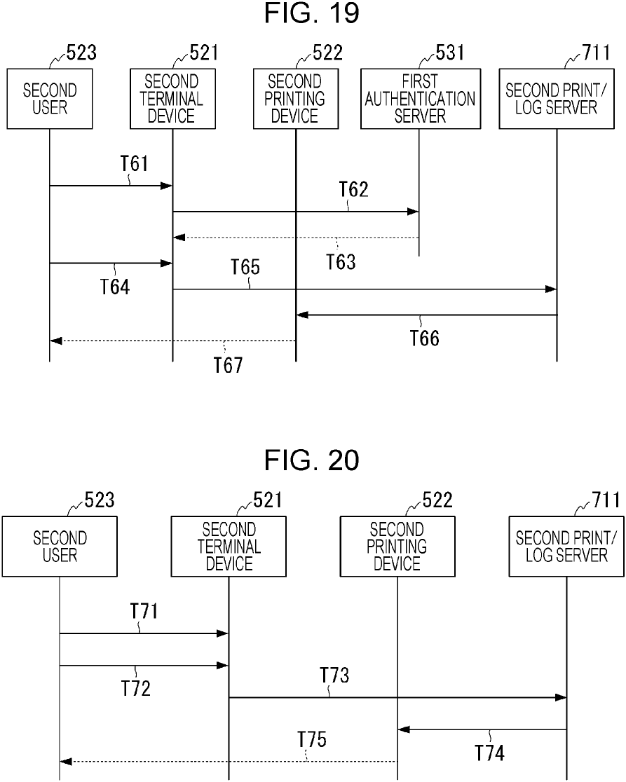

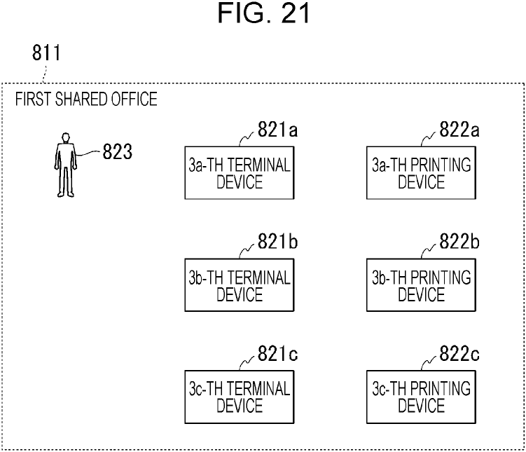

Examples of a procedure for performing a process in the fourth information processing system 4 are described below with reference to FIGS. 19 and 20.

FIGS. 19 and 20 illustrate the second user 523, the second terminal device 521, the second printing device 522, the first authentication server 531, and the second print/log server 711.

FIG. 19 is a diagram illustrating an example of the procedure for performing the process in the fourth information processing system 4 according to the fourth embodiment.

This example corresponds to the communication state illustrated in FIG. 17 and corresponds to a case where official printing is performed.

In a process T61, the second user 523 operates the operation unit of the second terminal device 521 to perform login.

In this example, the domain of the 2a-th company 512a is used as the login destination.

In a process T62, the second terminal device 521 causes the second terminal side authentication communication unit 651 to transmit an authentication request to the first authentication server 531 for the use of the domain of the 2a-th company 512a as the login destination.

In a process T63, when the first authentication server 531 authenticates the authentication request as a valid request, the first authentication server 531 transmits, to the second terminal device 521, information indicating that the authentication request is valid. As a result, the second terminal device 521 receives the information.

In a process T64, the second user 523 operates the operation unit of the second terminal device 521 to enter a print instruction into the second terminal device 521. As a result, the second terminal device 521 receives the print instruction.

In a process T65, the second terminal device 521 causes the second print instructor 621 to transmit, based on the received print instruction, print data indicating the print instruction to print a print job to the second print/log server 711 using authentication information.

In addition, the second terminal device 521 causes the second terminal side information transmitter 622 to transmit log data including information regarding the printing of the print job to the second print/log server 711 using the authentication information. As a result, the second print/log server 711 performs processing of storing the received log data, processing of transmitting information based on the log data to the second expense management device 533, and the like.

The print data and the log data may be integrated or separated, for example.

In a process T66, the second print/log server 711 transmits, in accordance with the print instruction to print the print job received from the second terminal device 521, print data indicating the print instruction to print the print job to the second printing device 522. As a result, the second printing device 522 receives the print data from the second print/log server 711 and print the print job.

In a process T67, the second user 523 obtains printed matter generated by the second printing device 522.

The processing T67 is performed at any timing after the processing T66.

FIG. 20 is a diagram illustrating another example of the procedure for performing the process in the fourth information processing system 4 according to the fourth embodiment.

This example corresponds to the communication state illustrated in FIG. 18 and corresponds to a case where private printing is performed.

In a process T71, the second user 523 operates the operation unit of the second terminal device 521 to perform login.

In this example, the domain of the 2a-th company 512a is not used as a login destination.

In this example, a private domain destination is used as a login destination.

In a process T72, the second user 523 operates the operation unit of the second terminal device 521 to enter a print instruction into the second terminal device 521. As a result, the second terminal device 521 receives the print instruction.

In a process T73, the second terminal device 521 causes the second print instructor 621 to transmit, based on the received print instruction, print data indicating the print instruction to print a print job to the second print/log server 711.

In addition, the second terminal device 521 causes the second terminal side information transmitter 622 to transmit log data including information regarding the printing of the print job to the second print/log server 711. As a result, the second print/log server 711 performs processing of storing the received log data, processing of transmitting information based on the log data to the second expense management device 533, and the like.

The print data and the log data may be integrated or separated, for example.

In a process T74, the second print/log server 711 transmits, in accordance with the print instruction to print the print job received from the second terminal device 521, print data indicating the print instruction to print the print job to the second printing device 522. As a result, the second printing device 522 receives the print data from the second print/log server 711 and prints the print job.

In a process T75, the second user 523 obtains printed matter generated by the second printing device 522.

The processing T75 is performed at any timing after the processing T74.

In the examples illustrated in FIGS. 19 and 20, every time the printing of a print job is performed, the second terminal device 521 transmits log data including information regarding the printing of the print job to the second print/log server 711.

As another configuration example, the second terminal device 521 may store information regarding printing performed on a print job in the second terminal side storage unit 614 and transmit log data including the information to the second print/log server 711 at a predetermined timing. The timing may be defined in advance or may be timings at fixed time intervals, for example.

In the second terminal device 521, the timing of performing printing and the timing of outputting log data including information regarding the printing may be the same or may be any other timings, for example. As a specific example, the timing of outputting the log data regarding the printing may be after the execution of the printing, during the execution of the printing, or before the execution of the printing.

The log data may be generated based on a history regarding the printing.

In the fourth information processing system 4 according to the present embodiment, it is possible to improve the accuracy of classifying expenses required for printing.

In the fourth information processing system 4 according to the present embodiment, for example, it is possible to identify official printing and private printing and to appropriately classify expenses required for the printing. In the present embodiment, for example, it is possible to correctly calculate an expense for printing for official purposes when the user works from home.

In the fourth information processing system 4 according to the present embodiment, for example, an expense regarding official printing may be calculated and settled and an expense regarding private printing may not be calculated and settled.

In the fourth information processing system 4 according to the present embodiment, for example, the second expense management device 533 can automatically settle an expense.

In the present embodiment, as information regarding an expense, one or more of information indicating whether the expense needs to be paid, a source that pays the expense, a destination to which the expense is paid, the amount of a resource used, and information indicating private printing or official printing can be used.

In the present embodiment, for example, the second terminal device 521 may cause the second terminal side information transmitter 622 to transmit only log data regarding official printing out of the log data regarding the official printing and log data regarding private printing to the second print/log server 711 or to transmit both of the log data regarding the official printing and the log data regarding the private printing to the second print/log server 711.

In the present embodiment, when log data and print data are transmitted from the second terminal device 521 to the second print/log server 711, the log data and the print data may not be clearly distinguished. In this case, various types of information may be distributed to the log data and the print data.

In the present embodiment, it is possible to provide an information processing method of performing the information processing in the fourth information processing system 4.

Modifications of the first to fourth embodiments are described below.

FIG. 21 is a diagram illustrating an example of a configuration of a first shared office 811 according to a modification of the embodiments.

In the first shared office 811, a 3a-th terminal device 821a, a 3b-th terminal device 821b, a 3c-th terminal device 821c, a 3a-th printing device 822a, a 3b-th printing device 822b, and a 3c-th printing device 822c are disposed.

In the example illustrated in FIG. 21, the three terminal devices are disposed in the first shared office 811. However, the number of terminal devices in the first shared office 811 may be 1 or 2 or may be 4 or more.

In addition, in the example illustrated in FIG. 21, the three printing devices are disposed in the first shared office 811. However, the number of printing devices in the first shared office 811 may be 1 or 2 or may be 4 or more.

When a third user 823 uses the first shared office 811, the third user 823 may be permitted to use one or more of the terminal devices disposed in the first shared office 811 and one or more of the printing devices disposed in the first shared office 811.

In this case, for example, the one or more terminal devices may have the same functions as those of the first terminal device 21 and operate in the same manner as the operation described in the first or second embodiment.

In addition, for example, the one or more terminal devices may have the same functions as those of the second terminal device 521 and operate in the same manner as the operation described in the third or fourth embodiment.

When the third user 823 uses a printing device disposed in the first shared office 811 to perform official printing, a company or the like that is an organization for which the official printing is performed may pay an owner of the printing device for an expense required for the printing, for example.

The owner of the printing device to whom the expense is paid may be an owner of the first shared office 811, for example.

As information identifying the destination to which the expense is paid, for example, either one or both of information identifying the printing device that performed printing of a print job and information regarding a section to which the printing device belongs may be used.

As the information regarding the section to which the printing device belongs, for example, either information identifying the first shared office 811 to which the printing device belongs or information identifying the owner of the first shared office 811 may be used.

When the third user 823 uses a printing device disposed in the first shared office 811 to perform private printing, for example, the third user 823 pays the owner of the first shared office 811 for an expense required for the printing. The expense may be included in the usage fee of the first shared office 811, for example.

A case where a single user belongs to a plurality of organizations for which official printing is performed is described below.

When the same user performs printing to work for each of the organizations, for example, the organizations corresponding to the printing may pay the user for expenses required for the printing.

Log data includes information identifying the organizations to which the printing belongs, for example.

As an example, when addresses for VPN connections of the organizations are different, the organizations may be identified by the addresses. As the addresses, for example, IP addresses may be used.

As another example, when domains for connections of the organizations are different, the organizations may be identified by the domains.

When a single user belongs to different sections, expenses regarding printing may be settled for each of the sections. The expenses may be allocated to the plurality of sections to which the user belongs.

In the present embodiment, for example, in addition to identifying official printing and private printing, when a single user belongs to a plurality of organizations, it is possible to identify official printing for each of the organizations.

In the embodiments described above, as each of the printing devices, for example, a multifunction peripheral having a printing function and another function may be used.

The other function may be one or more of a scanner function, a copy function, a facsimile function, and the like, for example.

A program that implements a function of any constituent unit of any of the devices described above may be recorded in a computer-readable recording medium, read into a computer system, and executed by the computer system. The “computer system” includes an operating system or hardware such as peripheral equipment. The “computer-readable recording medium” is a portable medium such as a flexible disk, a magnetooptical disc, a read-only memory (ROM), or a compact disc-ROM (CD-ROM) or is a storage device such as a hard disk included in the computer system. The “computer-readable recording medium” may store the program for a certain time period and may be a volatile memory included in the computer system that serves as a server or a client when the program is transmitted via a network such as the Internet or a communication line such as a telephone line. The volatile memory may be a RAM. The volatile memory may be a RAM. The recording medium may be a non-transitory recording medium.

The program may be transmitted from the computer system storing the program in a storage device or the like to another computer system via a transmission medium or a transmission wave in the transmission medium. The “transmission medium” that transmits the program is a medium having a function of transmitting information, like a network such as the Internet or a communication line such as a telephone line.

The program may be provided to implement some of the functions described above. The program may be a so-called differential file that can implement the functions in combination with a program already recorded in the computer system. The differential file may be referred to as a differential program.

A function of any constituent unit included in any of the devices described above may be implemented by a processor. Each of the processes described in the embodiments may be implemented by the processor operating based on information of a program or the like and a computer-readable recording medium storing the information of the program or the like. The processor may implement the functions of each of the units by individual hardware or by integrated hardware. The processor includes hardware, which may include at least one of a circuit that processes a digital signal and a circuit that processes an analog signal. The processor may be provided with either one or multiple circuit devices mounted on a circuit substrate or one or multiple circuit elements. As the circuit devices, integrated circuits (ICs) may be used. As the circuit elements, resistors, capacitors, or the like may be used.

The processor may be a CPU. However, the processor is not limited to the CPU. Various processors such as a graphics processing unit (GPU) and a digital signal processor (DSP) may be used. The processor may be a hardware circuit such as an application specific integrated circuit (ASIC). The processor may be constituted by a plurality of CPUs. Alternatively, the processor may be constituted by hardware circuits such as a plurality of ASICs. The processor may be constituted by a combination of a plurality of CPUs and hardware circuits such as a plurality of ASICs. The processor may include one or more of an amplifier circuit that processes an analog signal, a filter circuit, and the like.

Although the embodiments are described above in detail with reference to the drawings, specific configurations are not limited to the embodiments, and design and the like that do not depart from the gist of the present disclosure are included in the present disclosure.

What is claimed is:

1. An information processing system comprising a terminal device and an information processing device, wherein
the terminal device includes
a print instructor that transmits a print instruction to print a print job, and
an information transmitter that transmits predetermined information regarding the printing of the print job to the information processing device, and
the predetermined information includes
expense-related information that is information regarding an expense for the printing of the print job, and
connection-related information that is either one or both of information of a VPN connection and information of a login destination or is information based on at least one of the information of the VPN connection and the information of the login destination.

2. The information processing system according to claim 1, wherein
the expense-related information includes information identifying whether the expense needs to be paid.

3. The information processing system according to claim 1, wherein
the expense-related information includes information identifying a source that pays the expense.

4. The information processing system according to claim 1, wherein
the expense-related information includes information identifying a destination to which the expense is paid.

5. The information processing system according to claim 1, wherein
the expense-related information includes information specifying an amount of a resource used for the printing of the print job.

6. The information processing system according to claim 1, wherein
the connection-related information includes information identifying whether the printing of the print job is private printing or official printing.

7. The information processing system according to claim 1, further comprising a print controller that causes the print job to be stored in a storage and causes a printing device to print the print job stored in the storage.

8. The information processing system according to claim 7, further comprising the printing device.

9. A terminal device comprising:
a print instructor that transmits a print instruction to print a print job; and
an information transmitter that transmits predetermined information regarding the printing of the print job to an information processing device, wherein
the predetermined information includes
expense-related information that is information regarding an expense for the printing of the print job, and
connection-related information that is either one or both of information of a VPN connection and information of a login destination or is information based on at least one of the information of the VPN connection and the information of the login destination.

10. An information processing device comprising a received information processor that processes predetermined information regarding printing of a print job received from a terminal device, wherein
the predetermined information includes
expense-related information that is information regarding an expense for the printing of the print job, and
connection-related information that is either one or both of information of a VPN connection and information of a login destination or is information based on at least one of the information of the VPN connection and the information of the login destination.

11. An information processing method comprising:
causing a terminal device to transmit a print instruction to print a print job; and
causing the terminal device to transmit predetermined information regarding the printing of the print job to an information processing device, wherein
the predetermined information includes
expense-related information that is information regarding an expense for the printing of the print job, and
connection-related information that is either one or both of information of a VPN connection and information of a login destination or is information based on at least one of the information of the VPN connection and the information of the login destination.
